(19) United States
(12) Patent Application Publication
(10) Pub. No.: US 2025/0383933 A1
(43) Pub. Date: Dec. 18, 2025

(54) METHOD FOR AUTOMATICALLY DEPLOYING ARTIFICIAL INTELLIGENCE MODELS

(71) Applicant: Chimes AI, Inc., New Taipei City (TW)

(72) Inventor: T. C. Hsieh, New Taipei City (TW)

(73) Assignee: Chimes AI, Inc., New Taipei City (TW)

(21) Appl. No.: 19/230,944

(22) Filed: Jun. 6, 2025

Related U.S. Application Data
(60) Provisional application No. 63/660,658, filed on Jun. 17, 2024.

(51) Int. Cl. G06F 9/50; G06F 11/34

(52) U.S. Cl. CPC G06F 9/5055; G06F 11/3409

(57) ABSTRACT

The invention provides a method for automatically deploying artificial intelligence models, which simplifies a model building process through systematic data preprocessing, model selection, parameter optimization and performance monitoring mechanisms, and dynamically updates or switches models in an application environment to maintain overall prediction performance at the best state while improving the performance of the model in multiple application environments.

This disclosure claims priority to and the benefit of U.S. Provisional Application No. 63/660,658, filed on 17 Jun. 2024, which is incorporated herein by reference for all purposes

### BACKGROUND OF THE INVENTION

### Field of the Invention

The invention relates to the technical field of artificial intelligence, in particular, to a method for automatically deploying artificial intelligence models.

### Description of the Prior Art

In the digital business operating environment now, more and more organizations are trying to use artificial intelligence (AI) or machine learning (ML) technologies to assist in decision-making, optimize processes and improve overall efficiency. In related fields, the common development process for machine learning models often requires collecting data, performing feature engineering and model selection, and finally deploying the constructed model to the actual operation scenario. However, the prior art generally faces the following problems.

First, the deployment process is often too cumbersome. When the AI models are introduced, most companies or organizations must repeatedly transfer and adapt between the personnel development environment and the actual application environment. This process is easily limited by the incomplete integration of data sources and system architecture, which is time-consuming and prone to errors. In addition, when the existing data reaches tens of millions or even billions of records, traditional artificial intelligence or machine learning models cannot be effectively built without proper data preprocessing. On the other hand, when external conditions or data distribution change, the previously deployed models often lose accuracy or stability. In the prior art, people are usually required to re-collect data, repeatedly test algorithms, and manually optimize settings to maintain the performance of models. This operation and maintenance method that relies so heavily on manual labor is not only time-consuming and labor-intensive, but also difficult to respond to business needs in real time.

Moreover, the lack of model interpretability is also a major obstacle. After traditional AI models are deployed, it is often difficult to clearly present prediction logic or key features to users or decision makers. If the source of model predictions or the causes of deviations are required to be explored deeply, complicated additional tools or experimental analysis are often needed, which increases communication costs and introduction barriers. This makes it impossible for operations administrators without professional background to effectively control and use model results.

In addition, although most existing systems can monitor the performance of model prediction outputs, most of them are limited to passive detection. Once degradation for the model performance is observed, it is usually necessary for personnel to manually evaluate whether to replace the model or conduct a new round of training, rather than automatically comparing other feasible candidate models or quickly launching optimization mechanisms. The lack of such automatic capabilities for dynamic updates and replacements makes it difficult to adjust overall operational efficiency and forecasting quality in real time as the data environment changes.

In a manufacturing scenario, if a factory or enterprise wishes to conduct an in-depth analysis of the energy consumption and usage efficiency of each device or production line unit, it is often limited by the funding and operation and maintenance costs of existing measurement solutions. For example, most traditional factories or offices use a single large meter to count total electricity consumption, but cannot break it down to individual machines or production units. If independent meters are to be installed for accurate measurement, each unit or machine requires additional hardware, installation, and operation and maintenance resources, resulting in high initial costs and long-term management burdens. Since these extra efforts are often difficult to recoup, and in practice often discourage companies from more sophisticated data collection and model applications.

Therefore, how to improve the adaptability of models to different data sources and automatically monitor and optimize AI models deployed in actual production or operation scenarios through intelligent data analysis and model management mechanisms while avoiding the need to significantly add or modify hardware equipment has become an important issue that requires urgent breakthroughs in the prior art. The above problems illustrate the challenges that the industry currently faces in deploying, operating and maintaining AI models, and also echo the necessity of quickly switching or optimizing models while maintaining reasonable costs. These deficiencies in technology and application are the motivation for further development and improvement of the invention.

### SUMMARY OF THE INVENTION

The main objective of the invention is to provide a method for automatically deploying artificial intelligence models, which may be executed in one or more systems, and not only simplifies a model building process through systematic data preprocessing, model selection and parameter optimization, and but also dynamically updates or switches models in an application environment to maintain overall prediction performance at the best state while improving the performance of the model in multiple application environments.

According to the above objective of the invention, a method for automatically deploying artificial intelligence models includes: receiving an operational data related to an operation or a performance of at least one physical system, the operational data coming from at least one data source; preprocessing the received operational data, including but not limited to lossless data compression, outlier removal and missing value imputation, to generate a structured dataset required for modeling; selecting at least one corresponding candidate algorithm based on at least one data feature in the structured dataset; constructing a plurality of artificial intelligence models each having a plurality of hyperparameter combinations according to at least one selected candidate algorithm; optimizing parameters of the plurality of artificial intelligence models; evaluating a performance metric of each of the artificial intelligence models and generating a corresponding model explanation result respectively; and selecting an optimized artificial intelligence model according to the performance metric, and deploying into an application environment corresponding to at least one data source.

After deploying the artificial intelligence model into the application environment, the method further includes steps of: generating a real-time data change based on at least one data source in the application environment, and monitoring the performance metric of the artificial intelligence model; executing an optimization of the artificial intelligence model automatically when the performance metric is lower than a predetermined threshold.

The executing an optimization of the artificial intelligence model further includes steps of: preprocessing a newly-added real-time data in the application environment; based on the newly-added real-time data, if the volume of real-time data is large, performing lossless data compression, followed by outlier removal, missing value imputation and updating the artificial intelligence model to determine a weight of a feature importance and selecting features that have a significant impact on a model performance to re-adjust a hyperparameter of the artificial intelligence model and/or a selected feature set; retraining the artificial intelligence model to generate a retrained artificial intelligence model; redeploying the retrained artificial intelligence model to the application environment.

After deploying the artificial intelligence model into the application environment, the method further includes steps of: generating a real-time data change based on at least one data source in the application environment, and monitoring the performance metric of the artificial intelligence model. Further, when the performance metric is lower than a predetermined threshold, the method executes steps of: retrieving at least one unselected artificial intelligence model that has been previously constructed but not been deployed; comparing the model explanation result corresponding to each of the unselected artificial intelligence models with a changing state of the real-time data; selecting the unselected artificial intelligence model that best matches the changing state of the real-time data; deploying the unselected artificial intelligence model to the application environment to replace the existing artificial intelligence model.

The selecting at least one corresponding candidate algorithm based on the at least one data feature in the structured dataset further includes steps of: selecting at least one candidate algorithm from an algorithm library according to the at least one data feature; using a random portion of the data in the structured dataset to train the at least one candidate algorithm and evaluating according to at least one performance metric; selecting the at least one candidate algorithm with superior performance on the at least one performance metric.

The optimizing parameters of the plurality of artificial intelligence models further includes steps of: adjusting the plurality of hyperparameters of each of the artificial intelligence models, the hyperparameters including a learning rate, a regularization coefficient, a model architecture parameter and a batch size; executing optimization based on a preset parameter adjustment strategy, the parameter adjustment strategy being a grid search, a random search or a heuristic optimization method.

For different parameter combinations of each of the artificial intelligence models, a comparison is performed based on at least one performance metric, and selecting a parameter combination with superior performance is selected as a final parameter setting of the artificial intelligence model.

The model explanation result is generated based on a prediction output and an internal model parameters after training each of the parameter combinations.

The evaluating a performance metric of the plurality of the artificial intelligence models and generating a corresponding model explanation result respectively further includes steps of: for each of the artificial intelligence models, according to a prediction output and an internal model parameters, calculating a global feature contribution score for at least one data feature based on a prediction output and internal model parameters, wherein the prediction output is an overall prediction output for the structured dataset; calculating a local influence value for at least one data feature based on a single data instance or a representative data subset selected from the structured dataset, in combination with the global feature contribution score; based on the global feature contribution score and the local influence value, simulating the corresponding model output for different values of at least one data feature, and calculating a variation range of the model prediction output or classification probability caused by changes in the feature value.

Compared with the prior art, the invention has the following beneficial effects:

(1) Fully-automatic model building and deployment: The method may automatically complete processes such as preprocessing, algorithm selection, and model optimization for input operational data, greatly simplifying the tediousness of manual intervention, thus shortening the model development cycle and reducing maintenance costs.

(2) Dynamic monitoring and automatic update mechanism: By continuously monitoring the performance of the model deployed in the application environment, once declined performance of the model or the significant changes of the data distribution are detected, the system may automatically trigger the optimization or retraining process to further quickly adjust the model parameters and features to ensure that the model is maintained in the best state in real time.

(3) Comparison and replacement of multiple models: Compared with the traditional approach of only iterating a single model, the method retains and manages multiple candidate models (including the unselected models that are previously built but not yet launched); when the performance of the existing model declines, the method may automatically compare the explanation information of these candidate models with the new data distribution, so as to quickly select a more suitable model to launch for shortening the decision time and avoiding lengthy retraining processes.

(4) Parallel global and local explanations: While evaluating the performance of models, the method also analyzes the global feature contribution score of each feature and the local impact value of a single instance, assisting users understand the decision logic of models and identify important features that affect predictions, and further simulates the prediction differences caused by changes in the values of each feature, thereby improving model transparency and interpretability.

(5) Flexible adaptation to multiple data sources: Through the automatic deployment process and continuous optimization mechanism, the system may process operational data from different data sources simultaneously or in turn. Even if an enterprise may only use simplified measurement devices or a single unified measurement (for example, using a large electricity meter to record various energy consumption), the artificial intelligence model constructed by the method may still be dynamically updated and adjusted, lowering the threshold for hardware installation and operation and maintenance.

In summary, the method emphasizes an artificial intelligence model management process that is both automatic, dynamic, and interpretable, and may not only quickly deploy the initial model, but also automatically monitor and replace or optimize the model in subsequent operations and maintenance, while providing users with explanation results that show the rationale behind the internal decisions of models, thereby solve the various defects of the prior art in deployment efficiency, operation and maintenance difficulty and interpretability. Through the above-mentioned improvement mechanism, the feasibility and economic benefits of enterprises or organizations introducing artificial intelligence solutions in multiple application scenarios may be effectively improved.

In order that the objectives, technical solutions and beneficial effects of the invention will become more apparent, the invention will be described in more detail with reference to the drawings and examples above.

### BRIEF DESCRIPTION OF THE DRAWINGS

FIG. 1 is a main flow chart of a method for automatically deploying artificial intelligence models provided by an embodiment of the invention;

FIG. 2 is a flow chart of a first dynamic optimization of the method for automatically deploying artificial intelligence models provided by an embodiment of the invention;

FIG. 3 is a flow chart of a second dynamic optimization of the method for automatically deploying artificial intelligence models provided by an embodiment of the invention.

In the drawings:
S101, S102, S103, S104, S105, S106, S107: Step;
S201, S202, S203, S204, S205, S206, S207, S208: Step;
S301, S302, S303, S304, S305, S306, S307: Step.

### DESCRIPTION OF THE PREFERRED EMBODIMENTS

The embodiments of the invention will be further described below with reference to the accompanying drawings. Wherever possible, in the drawings and the description, the same reference numbers refer to the same or similar components. It should be understood that components not specifically shown or described in the drawings or the specification are of forms generally known to those skilled in the art. Those skilled in the art can make various changes and modifications based on the contents of the invention.

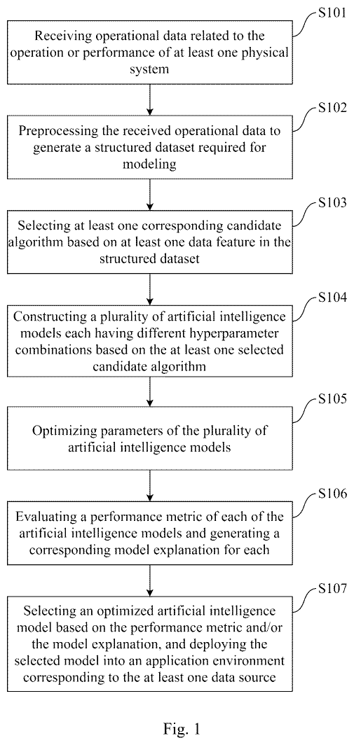

As shown in FIG. 1, a method for automatically deploying artificial intelligence models according to an embodiment includes steps S101 to S107, which are described in detail as follows.

Step 101: An operational data related to an operation or a performance of at least one physical system is received. The operational data may include historical operating data, historical performance records or other data related to the operating status of the system, such as operating status data of machinery and equipment, electricity consumption or energy consumption information or product production efficiency or quality data.

In the step S101, the system provides a data management interface and related functions for importing and managing operational data from different sources, including but not limited to CSV files, relational databases, time series databases or No-SQL databases.

The system using the method may also provide a “add/edit/delete data project” function, and users can create multiple data items based on actual applications.

Specific examples of the step S101 may be:

(1) The hourly-recorded electricity consumption (kWh) and peak electricity consumption, as well as the actual production quantity, scrap quantity, production line utilization rate and other data of each production line and each shift are obtained from two data sources of the factory total electricity consumption meter and the production line ERP (Enterprise resource planning) system.

(2) A data project called “Factory Energy Consumption Analysis” is created.

(3) The total electricity consumption records for the past three months are uploaded to the project through the API/database link provided by the system, and the record fields (time, electricity consumption, device number, etc.) are defined.

(4) The production volume of each production line is imported from the ERP system.

(5) Null values in the system are checked and cleaned up (if the electricity consumption record for a certain period is missing, then this situation is marked and interpolation or removal are chosen to perform), and extreme outliers are excluded.

(6) The final output is a structured table (such as a CSV file or database table) containing fields such as “timestamp, power consumption, production line ID, output, product type”.

Step S102: The received operational data is preprocessed to generate a structured dataset required for modeling. The purpose of the step is to further preprocess the operational data that are previously managed and selected to generate a structured dataset that can be used for model building.

In the step, the system may read the fields and number of records from the specified source according to the data projects selected by the user in the step S101, and remove unnecessary or duplicate data fields through a selection and sorting mechanism. Then, the system provides multivariate or single variable visualization functions, and the users can observe the data distribution of different time periods, products or machines through charts. During this process, if null values or abnormal values are detected, the system will prompt the user to select “eliminate”, “replace with specified value” or “mark as Missing” to ensure that subsequent training is not affected by noise. Taking factory applications as an example, if it is found that the electricity consumption in a certain period of time is much higher than the normal range, it is possible that the reading is wrong, and then the user can discard the data or make reasonable adjustments according to the actual situation. In addition, if data from different sources differ in time series, the embodiment also supports unifying the time zone or time format, and ensures that each piece of data corresponds to the same time section through an alignment mechanism.

To assist users in data exploration, the system will generate a “Data Exploration Report” based on the selected results, which contains basic statistics (such as mean, standard deviation, maximum/minimum values) and simple visualization charts (such as scatter plots, line charts, correlation coefficient heat maps, etc.), so that users can evaluate data quality at a glance. In the last, the system outputs the cleaned dataset into a standardized format (such as CSV, DataFrame, or other structured archives), which may be directly used by subsequent steps. In this way, the entire preprocessing process may effectively reduce the noise and inconsistency of the original data to improve the success rate and accuracy of model training.

Step S103: At least one corresponding candidate algorithm is selected based on at least one data feature in the structured dataset.

In the step, the structured dataset generated by the steps S101 to S102 is first checked, including the field attributes (such as whether the target variable is continuous or categorical) and the data distribution. Then, according to the user needs or automatic mechanisms, suitable candidate algorithms are selected, such as linear regression, random forest, or support vector machine. If the data is large-volume and the labels are unclear, unsupervised or semi-supervised models may also be selected. If higher customization is required, the system allows the selection of “Customized Algorithm” to integrate user-defined functions or algorithm logic.

For example, if the analysis focuses on predicting the future electricity consumption of the factory, and the target field (electricity consumption value) is continuous data, the system may present multiple regression algorithms (such as generalized linear regression, random forest regression, extreme gradient boosting, etc.) in the candidate list; if a factory wants to identify shifts with “abnormal electricity consumption,” the system may provide algorithms of classification or anomaly detection type (such as isolation forests or univariate support vector machines). In the last, the system will proceed to subsequent steps such as “hyperparameter adjustment” and “model evaluation” according to the selected algorithm to complete a complete model development process. Therefore, the invention can effectively select the algorithm that is most suitable for the target data features and application scenarios under the guidance of automation or semi-automation.

Optionally, the step S103 may further be implemented by maintaining an “algorithm library” within the system. The algorithm library may contain various types of machine learning or deep learning algorithms, such as linear regression, random forest, extreme gradient boosting, support vector machine, convolutional neural network, etc. In factory energy consumption prediction applications, if the data features are continuous electricity consumption and production records, the system will initially screen the “Regression” algorithm; if outlier detection exists, algorithms with “Outlier Detection” capabilities may be targeted. For example,
(1) Regression: generalized linear regression, Glmnet, random forest regression, extreme gradient regression, convolutional neural network regression;

(2) Classification: Logistic regression, random forest, extreme gradient classification, support vector machine, convolutional neural network classifier;

(3) Outlier detection (unlabeled or partially labeled data): principal component analysis, isolation forest, univariate support vector machine, etc.

To compare multiple candidate algorithms in a short period of time, the system compresses data from the structured dataset set as a “quick test set”. This compressed dataset may represent the overall distribution features, but at the same time has low training cost. Taking analysis on factory electricity consumption as an example, the complete data size of only the past week or part of the production line data is hundreds of thousands of records; through data compression technology, these data may be used for preliminary training and testing of various algorithms to shorten the experimental cycle.

For each selected candidate algorithm, the system uses the compressed data to perform short-term training and calculates the corresponding performance metrics (such as RMSE and MAE for regression models, or Accuracy and F1-score for classification models). According to the test results of each algorithm, the system selects one or more algorithms with the best performance in terms of the metrics of interest and records them as “final candidate algorithms”. Once the final candidate algorithm is determined, the system may further conduct formal model training on complete or larger data sets, and apply automatic parameter adjustment strategies (such as grid search, random search) to obtain the optimal parameter combination, which will then be incorporated into subsequent “model performance evaluation” and “model explanation” stages.

Step S104: A plurality of artificial intelligence models are constructed according to at least one selected candidate algorithm.

In the step, according to the candidate algorithms selected in the step S103 (such as generalized linear regression, random forest, extreme gradient boosting, etc.), one or more artificial intelligence model versions are automatically or semi-automatically created for each algorithm. Specific methods include but are not limited to the following processes:

(1) Multi-model initial construction: The system trains multiple sets of models using different initial parameters or random seeds for each selected algorithm. Taking factory electricity consumption prediction as an example, 15 models may be generated for “Random Forest”, and each model uses a different number of trees or sample sampling strategies when being initiated; at the same time, different regularization coefficients are used to generate multiple versions for the “Linear Regression” model.

(2) Customizable model program or external algorithm: If the user needs customized algorithm logic, the system may load external program code or specific mathematical function through “customized algorithm”. In this case, multiple customized models may also be generated according to different initial parameters or hyperparameter configurations to expand adaptability to various data distributions.

(3) Temporary storage and waiting for subsequent parameter adjustment: After these models are initially generated, the models may only undergo basic training and verification, and the results are stored in the system. The system will also record information such as the algorithm name, initial parameters, training set performance, etc. corresponding to each model.

For example, in the factory electricity consumption prediction scenario, the step S104 may generate multiple model versions with different algorithms or configurations at one time, such as “random forest regression”, “generalized linear regression (including L1 regularization)”, “XGBoost regression”, etc. The user or the system itself may compare the performance and stability of each model in subsequent tests and ultimately select the combination with the best performance for deployment.

Step S105: Parameters of the plurality of artificial intelligence models are optimized.

The operation and implementation methods in the step include but are not limited to the following processes:

(1) Multi-model initial evaluation: Since the plurality of artificial intelligence models have been constructed in the step S104, each model uses the same or different algorithms and initial parameters for settings. Therefore, the step will first perform a basic evaluation of these models and collect metrics such as loss function value, accuracy, RMSE, etc. as the basis for subsequent parameter adjustment.

(2) Automatic parameter tuning strategy: Then different hyperparameter combinations are tried one by one according to the preset parameter adjustment strategy (such as grid search, random search, or heuristic methods such as Bayesian optimization). For example, in the factory electricity consumption prediction scenario, if the random forest algorithm is used, the system will test different numbers of trees, maximum depths, number of tree nodes, etc.; if linear regression is used, the regularization coefficient, learning rate, etc. will be adjusted. Through multiple training and k-fold Cross-validation, the parameter combination that performs well on certain metrics is found out.

(3) k-fold Cross-validation and performance comparison: To improve the reliability of parameter adjustment, k-fold Cross-validation may be performed under each parameter combination, and metrics such as average error or accuracy may be calculated. The performance of each combination on the test set will be recorded for subsequent integration and comparison. If for classification problems, the performance may also be measured by metrics such as F1-score, Precision/Recall, etc. If the problem is unlabeled or semi-labeled outlier detection, the performance is measured by metrics such as TPR (True Positive Rate), Contamination, and Min-Distance.

(4) Parameter optimization results: The system will eventually select the combination with the best performance in terms of comprehensive metrics (such as RMSE, Accuracy or other customized metrics) from all the tried parameter combinations, and mark the combination as the “final setting”. At this point, the optimal parameters for each model have been determined and may be used for further evaluation and explanation in the next stage.

Optionally, in the step S105, the system may further pre-define a set of “hyperparameter search ranges” covering learning rate, regularization factor, model architecture parameters (such as tree depth, number of neurons, etc.) or batch size. For example, in random forest, the system may perform grid search for the “number of trees (N_estimators)” and “maximum depth (Max_depth)”; in XGBoost, the “learning rate (learning rate)” and “L2 regularization (l2_reg)” are adjusted at the same time. Optional parameter adjustment strategies include Grid Search, Random Search, or Bayesian Optimization (a heuristic method), which is determined by the system or the user. If the data volume is large and the parameter space is wide, random search or Bayesian optimization may also be selected to improve efficiency. The system automatically generates multiple hyperparameter combinations according to the above “search range” and “parameter adjustment strategy”, and performs multiple training and testing on each model. During the process, the system will record information such as training time, memory usage, and performance metrics for each parameter combination.

After the above training process is completed, the system will collect the main performance metrics of each set of parameter combinations (such as RMSE, MAE, MAPE, Accuracy, F1-score, etc., depending on the application type). For the same model, the system may plot the results of “parameter combination vs. performance metric” and automatically select the parameter combination with the best performance on the metric and set as the “final parameter setting”. For example, if the random forest has the lowest RMSE performance when the number of trees is equal to 200 and the maximum depth is equal to 10, then this combination will be considered as the final hyperparameters of the model; similarly, if the extreme boosting model has the best performance when the learning rate is equal to 0.05 and the regularization coefficient is equal to 1.0, this combination will also be recorded as the final setting.

In addition to quantifying and comparing the performance metric, the system also generates corresponding explanation results for the model trained for each parameter combination. For example, SHAP (Shapley Value) or Feature Importance are used to display the importance of each feature to the prediction output. The changes in feature importance under different parameter combinations may also be compared to find out why certain parameter settings are particularly sensitive to specific features. Finally, after the training is completed, the system may output a comparison table or visualization report of “parameter combination, performance metric, feature contribution” to help the user or administrator better understand the operating logic and key basis of the model under different settings.

When the system completes the training and generates the explanation of all parameter combinations, it will ultimately select the combination with the best metrics and reasonable explanation results as the “final parameter setting” of the model based on the above performance comparison. If multiple models are being adjusted in parameters at the same time (such as random forest vs. extreme boosting), the optimal solution may be selected for each model, and the subsequent steps (such as the step S106) may further evaluate the performance and interpretability and then select one or more optimal models for deployment.

Step S106: A performance metric of each of the artificial intelligence models is evaluated and a corresponding model explanation result is generated respectively.

The operation and implementation methods in the step, especially the method for generating performance metrics and model explanation results, include but are not limited to the following processes:

(1) Model Evaluation Index: After the parameter adjustment in step S105 is completed, the system may perform a test or verification procedure for each artificial intelligence model. For example, in the regression scenario, metrics such as RMSE, MAE, and MAPE may be calculated; if for the classification problem, Accuracy, Precision, Recall and F1-score are measured, and even a confusion matrix is plotted to observe the accuracy of each category. Taking factory electricity consumption prediction as an example, the system will output multiple error metrics according to the difference between the actual electricity consumption value of the test data and the model prediction value, allowing the user to judge the model prediction effect.

(2) Model Evaluation Plots: To facilitate understanding of the model prediction status on test data, the system may automatically draw corresponding charts. For example, “Scatter Plot of Actual vs. Predicted Values” or “Residual Distribution Plot” in terms of regression or “ROC curve” or “PR curve” in terms of classification. These visualization tools allow users to more intuitively distinguish which models are closer to real data in predictions and which models can still maintain stability under abnormal conditions.

(3) Model Explanation: The system generates explanation results for each model simultaneously, which may include techniques such as Partial Dependence Plot (PDP) or Shapley Value to reveal the contribution of key features in model predictions. Taking factory applications as an example, if it is observed that “shift” and “temperature” have higher weights in electricity consumption predictions, the user may further adjust scheduling or capacity planning; if in a classification scenario, SHAP analysis may be used to analyze which feature is most likely to lead to a certain type of judgment, which helps to discover potential problems (such as equipment failure tendency).

Optionally, after the training and basic performance evaluation of the plurality of artificial intelligence models are completed (such as RMSE, Accuracy, F1-score, etc.), the system may further proceed to a more sophisticated explanation program to help the user deeply understand “which features play a key role in the model prediction outputs” and “how specific input feature values (input value) affect the final prediction.” The operation and implementation methods in the optional aspects of the embodiment include but are not limited to the following processes:

(1) Calculation of global feature contribution score: The system calculates the contribution of the entire structured dataset at the global level according to the training results and internal model parameters (such as tree structure and weight vector) of each artificial intelligence model (such as random forest regression, extreme boosting regression, etc.). Taking factory electricity consumption prediction as an example, the influence of features such as “shift”, “daily temperature”, and “electricity consumption in the previous period” in the global prediction can be determined through the native Feature Importance and SHAP value averaging of each algorithm, or through customized partial dependency analysis (Partial Dependence). For example, the system may conclude that the average importance of “temperature” is 0.35, “shift” is 0.25, etc., indicating that “temperature” has the highest weight in the overall prediction performance.

(2) Calculation of local influence values: Next, the system selects a single data instance (such as the electricity usage record of a specific production line on a certain day and a certain shift) or a small representative data subset (such as a random sampling of night shift production lines that month) and examines the influence of each feature on the prediction of the instance at the “local” level. For example, if the value of the feature “temperature” in a certain data record is particularly high and the model has a significant positive influence on this feature, then it can be calculated that the contribution to the final electricity consumption prediction values may reach +8 kWh; if the “shift” or “cumulative output” has only a small influence on this instance, the value may be relatively low. The system can accurately quantify the contribution of each feature to individual prediction outputs through Shapley Value, LIME (Local Interpretable Model-agnostic Explanations) or Partial Dependence Analysis for each record.

(3) Simulation of the range of variation of different feature values: Based on the above information of “global feature contribution score” and “local influence value”, the system further simulates “how the model output will change if the feature value changes”. Still, taking the factory electricity consumption as an example, if the sensitivity of “temperature” to the prediction outputs is required to be explored, the “temperature” may be let to be increased or decreased gradually between 15° C. and 35° C., and the corresponding changes in the predicted electricity consumption are observed. For example, the system may calculate that every increase of 1° C. will increase predicted electricity usage by 3 kWh˜5 kWh. In terms of classification (such as determining whether a shift is “abnormally high in energy consumption”), results such as “If the feature value changes, the probability of the shift being classified as ‘abnormal’ increases from 30% to 70%” may be presented, allowing administrators to make more accurate scheduling or maintenance decisions.

In the embodiment, the prediction logic of the model may be revealed in both global and local dimensions, and simulations may be performed under different feature values to calculate the range of changes in the prediction outputs or classification probabilities, so as to help the user not only know “which features are most important”, but also accurately grasp “in a specific situation, what influences the adjustment of a certain feature value will have on the final model output.” This integrated explanation mechanism is of significant help to artificial intelligence applications that require high reliability and transparency, such as factory production, medical diagnosis, and financial risk control.

Step S107: An optimized artificial intelligence model is selected according to the performance metric, and deployed into an application environment corresponding to at least one data source. The step is used to bring the best model that has completed optimization and evaluation online to assist in processing data from a specific data source.

In the step, all models that have undergone parameter optimization and performance evaluation are first summarized, and the model with the best performance is selected automatically or by the user. Next, the system packages the model (Packaging) into an executable file, container or service and deploys into a specified application environment, such as a factory management system, cloud platform or local server. If the model needs to process data in real time, daily inputs from the data source (such as sensor data, ERP records) may be integrated, and predictions or judgment results are continuously provided; if a batch analysis exists, the model operation may be triggered at a specific time. Taking factory electricity consumption application as an example, once deployed, the system will input current electricity consumption and production data into the model in real time or regularly, and output predictions for future electricity demand or abnormal situations, helping decision makers manage production lines more efficiently.

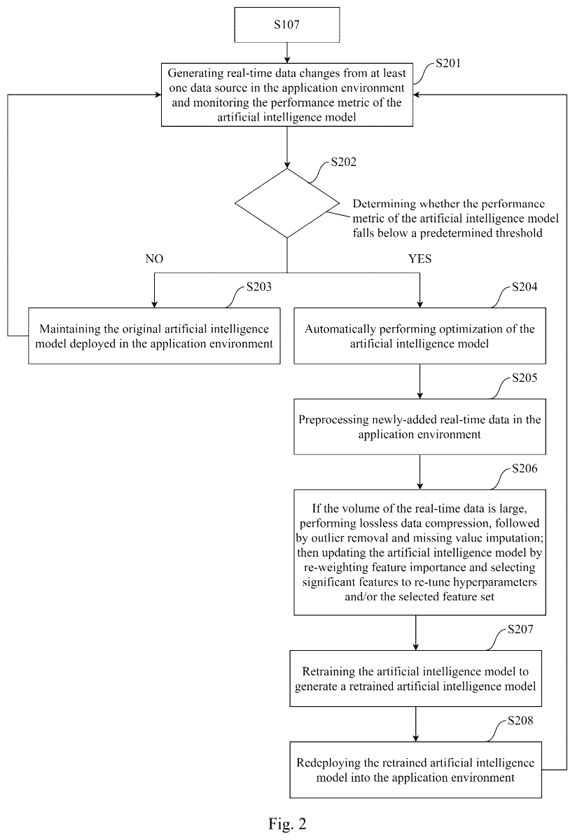

As shown in FIG. 2, according to another embodiment, the method includes providing a process for dynamically monitoring a performance of the artificial intelligence model configured in the application environment after executing the step S107, and optimizing the model, including steps S201 to S208, as detailed below.

Step S201: A real-time data change is generated based on at least one data source in the application environment, and the performance metric of the artificial intelligence model is monitored.

Step S202: Whether the performance metric of the artificial intelligence model is lower than predetermined thresholds; if no, the method proceeds to step S203; if yes, the method proceeds to step S204.

In the steps S201 to S202, after the artificial intelligence model is officially deployed and runs in the application environment, the system will continuously monitor the performance metrics (such as RMSE, Accuracy, or F1-score, etc.) of the model to ensure that the prediction outputs of the model remain at the expected level. If it is detected that the model performance begins to decline and the metric value is lower than a threshold set in advance by the user or the system (i.e., the predetermined threshold described in the step S202), the retraining process may be automatically triggered. If the system is configured to require personnel confirmation, the administrator will be notified and will manually click “retrain” to start the process (i.e., proceeding to execute steps S204 to S208).

Step S203: The original artificial intelligence model is maintained to be deployed in the application environment; then, the method returns to the step S201, i.e., the performance of the artificial intelligence model is continuously monitored.

Step S204: An optimization of the artificial intelligence model is executed automatically.

Step S205: A newly-added real-time data is preprocessed in the application environment.

In the step, the system will import the real-time data accumulated since the last training and perform necessary preprocessing, such as correcting the field format, handling null values and outliers, and merging the original structured datasets. Taking factory electricity consumption monitoring as an example, these new data may include the latest meter readings, shift information, and production capacity records.

Step S206: based on the newly-added real-time data, if the volume of real-time data is large, lossless data compression is performed, followed by outlier removal, missing value imputation and updating the artificial intelligence model to determine a weight of a feature importance and selecting features that have a significant impact on a model performance to re-adjust a hyperparameter of the artificial intelligence model and/or a selected feature set.

In the step, by comparing the feature distribution of newly-added data with that of the old data, the system may dynamically adjust the importance of features (for example, through SHAP or feature importance analysis), and then filter out the features that have the greatest influence on the prediction according to the results. If some features suddenly become less representative, or some new fields unexpectedly become more correlated with the target value, the feature set may be updated in this retraining.

Step S207: The artificial intelligence model is retrained to generate a retrained artificial intelligence model.

In the step, after feature selection is completed, the system will train the same or multiple candidate models again and evaluate the performance on the newly-added data. This process may be set to be fully automatic (Automatically retrain) or require user intervention (Manually retrain). When the user intervenes, the administrator may review the intermediate model error curve and the metric changes to decide whether to apply the final version.

Step S208: The retrained artificial intelligence model is redeployed to the application environment. After the step, the method returns to the step S201, i.e., the performance of the artificial intelligence model is continuously monitored and retrained.

In the step, if the retrained model performs better than the old model, the system will automatically, or after human confirmation, deploy the model back to the original application environment to replace the degraded model. Then, the new model may receive and predict real-time data of the application environment in real time; if the degradation for the model performance is detected again in the future, the above processes may be repeated to form a continuously-updated MLOps ecosystem.

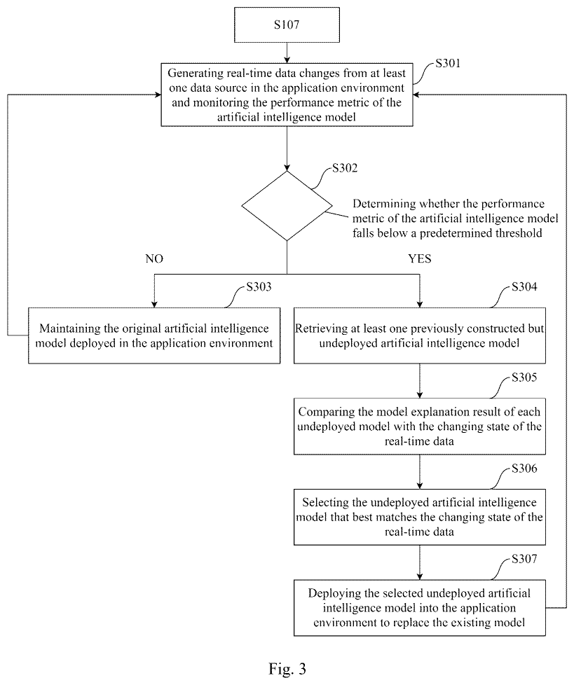

As shown in FIG. 3, according to still another embodiment, the method includes, after executing the step S107, providing a process for dynamically monitoring a performance of the artificial intelligence model configured in the application environment, and re-evaluating whether the previously-unselected artificial intelligence model is more suitable for the current application environment, which includes steps S301 to S307 and is described in detail as follows.

Step S301: A real-time data change is generated based on at least one data source in the application environment, and the performance metric of the artificial intelligence model is monitored.

Step S302: Whether the performance metric of the artificial intelligence model is lower than predetermined thresholds; if no, the method proceeds to step S303; if yes, the method proceeds to step S304.

Step S303: The original artificial intelligence model is maintained to be deployed in the application environment; then, the method returns to the step S301, i.e., the performance of the artificial intelligence model is continuously monitored.

Step S304: At least one unselected artificial intelligence model that has been previously constructed but not been deployed is retrieved.

Step S305: The model explanation result corresponding to each of the unselected artificial intelligence models is compared with a changing state of the real-time data.

Step S306: The unselected artificial intelligence model that best matches the changing state of the real-time data is selected.

Step S307: The unselected artificial intelligence model is deployed to the application environment to replace the existing artificial intelligence model. After the step, the method returns to the step S301, i.e., the performance of the replaced artificial intelligence model is continuously monitored.

The above steps S301 to S307 may be implemented by at least one actual application environment. Specifically, assuming that in the factory electricity consumption prediction application, the system has deployed an “existing model A” at the production site to predict the electricity demand of each production line in real time, then according to the embodiment, the system continuously collects real-time data from meter sensors, ERP production records, etc. in the step S301, and monitors the performance metrics (such as RMSE or MAPE) of the existing model A in the step S302. If the inspection result shows that the metric of model A is still higher than the predetermined threshold (indicating that the prediction error is low and the stability is good), the artificial intelligence model is directly maintained to continue to operate according to the step S303, and the method returns to the step S301 to continue monitoring. On the contrary, if it is detected that the accuracy of model A has obviously decreased (the performance metric has degraded to below the predetermined threshold), the system proceeds to the step S304 to retrieve from the plurality of candidate models that are “previously constructed but not launched at that time”. For example, previously, during the model development stage, random forest model B and extreme accuracy boosting model C are produced, but after initial comparison, both are not selected for formal deployment.

Therefore, in the step S305, the system will compare the feature distribution of newly-collected real-time data with the model explanation results (such as SHAP value or feature importance) corresponding to each of the unselected models to evaluate which unselected model has a better advantage in performance under the current data distribution. If the comparison finds that the prediction error of random forest model B is smaller in the recent night shift production line, model B is selected in the step S306, and model B is deployed to the factory application environment in the step S307 to replace model A with poor performance. After the replacement is completed, the entire process returns to the step S301 to continuously monitor the prediction performance of the newly-launched model B on the real-time data. If model B also experiences performance degradation in the future, the system may repeat the above processes and automatically or semi-automatically select other more suitable models or perform a retraining mechanism. In this way, the model may be flexibly switched to the artificial intelligence model that best suits the current data situation without spending too much time on modeling, thereby maintaining overall prediction performance and operational efficiency.

The system executing the method of automatically deploying artificial intelligence models in the above embodiments includes but is not limited to servers (such as centralized computing and data processing systems, used within an enterprise or in a data center), cloud platforms, edge computing devices (such as factory edge devices or smart IoT devices), high-performance computers (HPC), and IoT devices.

The above embodiments apply the method for automatically deploying artificial intelligence models, and each step thereof can be executed by one or more components/components of a “system”, “device”, “module”, or “unit”, for example, executed by a single processing module, or executed by multiple modules, such as a data receiving module, a preprocessing module, a screening module, a modeling module, an optimization module, a performance evaluation module, or a retraining module, etc., and a system for automatically deploying artificial intelligence models can also be formed by at least one of the above modules. Therefore, whether in the form of a single system/device/module/unit, a system/device formed by integrating multiple modules, or modules operating in multiple components, the method disclosed in the embodiment is applicable.

The above description is only to illustrate the preferred implementation mode of the invention, and is not intended to limit the scope of implementation. All simple replacements and equivalent changes made according to the patent scope of the invention and the content of the patent specification all belong to the scope of the patent application of the invention.

What is claimed is:

1. A method for automatically deploying artificial intelligence models, comprising:
receiving an operational data related to an operation or a performance of at least one physical system, the operational data coming from at least one data source;
preprocessing the received operational data to generate a structured dataset required for modeling;
selecting at least one corresponding candidate algorithm based on at least one data feature in the structured dataset;
constructing a plurality of artificial intelligence models each having a plurality of hyperparameter combinations according to at least one selected candidate algorithm;
optimizing parameters of the plurality of artificial intelligence models;
evaluating a performance metric of each of the artificial intelligence models and generating a corresponding model explanation result respectively; and
selecting an optimized artificial intelligence model according to the performance metric and/or the model explanation result, and deploying into an application environment corresponding to at least one data source.

2. The method for automatically deploying artificial intelligence models according to claim 1, wherein after deploying the artificial intelligence model into the application environment, the method further comprises steps of:
generating a real-time data changes based on at least one data source in the application environment, and continuously monitoring the performance metric of the artificial intelligence model;
executing an optimization of the artificial intelligence model automatically when the performance metric is lower than a predetermined threshold.

3. The method for automatically deploying artificial intelligence models according to claim 2, wherein the executing an optimization of the artificial intelligence model further comprises steps of:
preprocessing a newly-added real-time data in the application environment;
based on the newly-added real-time data, if the volume of real-time data is large, performing lossless data compression, followed by outlier removal, missing value imputation and updating the artificial intelligence model to determine a weight of a feature importance and selecting features that have a significant impact on a model performance to re-adjust a hyperparameter of the artificial intelligence model and/or a selected feature set;
retraining the artificial intelligence model to generate a retrained artificial intelligence model;
redeploying the retrained artificial intelligence model to the application environment.

4. The method for automatically deploying artificial intelligence models according to claim 1, wherein after deploying the artificial intelligence model into the application environment, the method further comprises steps of:
generating a real-time data change based on at least one data source in the application environment, and monitoring the performance metric of the artificial intelligence model;
when the performance metric is lower than a predetermined threshold, executing steps of:
retrieving at least one unselected artificial intelligence model that has been previously constructed but not been deployed;
comparing the model explanation result corresponding to each of the unselected artificial intelligence models with a changing state of the real-time data;
selecting the unselected artificial intelligence model that best matches the changing state of the real-time data;
deploying the unselected artificial intelligence model to the application environment to replace the existing artificial intelligence model.

5. The method for automatically deploying artificial intelligence models according to claim 1, wherein the selecting at least one corresponding candidate algorithm based on the at least one data feature in the structured dataset further comprises steps of:
selecting at least one candidate algorithm from an algorithm library according to the at least one data feature;
using a random portion of the data in the structured dataset to train the at least one candidate algorithm and evaluating according to at least one performance metric;
selecting the at least one candidate algorithm with superior performance on the at least one performance metric.

6. The method for automatically deploying artificial intelligence models according to claim 1, wherein the optimizing parameters of the plurality of artificial intelligence models further comprises steps of:
adjusting the plurality of hyperparameters of each of the artificial intelligence models, the plurality of hyperparameters comprising a learning rate, a regularization coefficient, a model architecture parameter and a batch size;
executing optimization based on a preset parameter adjustment strategy, the parameter adjustment strategy being a grid search, a random search or a heuristic optimization method.

7. The method for automatically deploying artificial intelligence models according to claim 6, wherein for different parameter combinations of each of the artificial intelligence models, a comparison is performed based on at least one performance metric, and selecting a parameter combination with superior performance is selected as a final parameter setting of the artificial intelligence model.

8. The method for automatically deploying artificial intelligence models according to claim 7, wherein the model explanation result is generated based on a prediction output and an internal model parameters after training each of the parameter combinations.

9. The method for automatically deploying artificial intelligence models according to claim 1, wherein the evaluating a performance metric of the plurality of the artificial intelligence models and generating a corresponding model explanation result respectively further comprises steps of:
for each of the artificial intelligence models, according to a prediction output and an internal model parameters, calculating a global feature contribution score for at least one data feature based on a prediction output and internal model parameters, wherein the prediction output is an overall prediction output for the structured dataset;
calculating a local influence value for at least one data feature based on a single data instance or a representative data subset selected from the structured dataset, in combination with the global feature contribution score;
based on the global feature contribution score and the local influence value, simulating the corresponding model output for different values of at least one data feature, and calculating a variation range of the model prediction output or classification probability caused by changes in the feature value.
